(19) United States
(12) Patent Application Publication
(10) Pub. No.: US 2026/0101879 A1
(43) Pub. Date: Apr. 16, 2026

(54) Integrated Submerged and Nonsubmerged Aquatic Incubator for Eggs and Larvae

(71) Applicant: Brian Lee Ashton, Wrangell, AK (US)

(72) Inventor: Brian Lee Ashton, Wrangell, AK (US)

(21) Appl. No.: 19/222,267

(22) Filed: May 29, 2025

Related U.S. Application Data
(60) Provisional application No. 63/653,699, filed on May 30, 2024.

(51) Int. Cl. A01K 61/17

(52) U.S. Cl. CPC A01K 61/17

(57) ABSTRACT

A recirculating aquaculture incubator integrating unsubmerged and submerged incubation space for eggs and alevin (larvae) with self-contained water supply, mechanical and monitoring systems, capable of scaling size and portability. The incubator resists fungal growth, thus reducing the need for chemical treatments. Its modular design may save on capital facility costs and is highly adaptable to a variety of aquaculture facilities.

### CROSS-REFERENCE TO RELATED APPLICATIONS

The present application is a non-Provisional of and claims the benefit of priority to U.S. Provisional application No. 63/653,699 filed on May 30, 2024. This disclosure is hereby incorporated by reference.

### BACKGROUND OF THE INVENTION

### 1. Field of the Invention

The present invention relates to a closed water system incubator with integrated submerged and unsubmerged incubation spaces with associated mechanical support systems. The invention further relates to the use of the incubator in the field of aquaculture as an effective means to reduce water consumption and avoid pathogens which reduce the productivity of aquaculture production.
Classification: A01K61/17 Hatching, e.g. incubators

### 2. Description of the Related Art

Aquaculture is both a growing commercial industry (aquatic farms) and environmental remediation process (restoration of biological life) in the world today. For purposes of clarity and understanding of this device, salmonid will be used in this narrative as the biological life used with this device. However, the device is not limited to salmonid use.

Many single pass, multiple pass and full (water) recirculation technologies are used today for “growing/rearing” salmon in hatcheries and fish farms across the world. Full or partial water recirculation aquaculture systems are often referred to as Recirculating Aquaculture Systems Technology (RASTECH).

There is a need for further advancement in the area of incubation of the salmonid embryos (egg and alevin (larval) stages of development). High volumes of water are required for conventional non-recirculating incubation, often with the necessary use of highly toxic chemicals (such as formaldehyde) for abating organic media growth (such as fungal or bacterial growth that can rapidly grow and destroy developing eggs and alevin). Additionally, land use, buildings, water sourcing, delivery and conditioning of water are also very expensive obstacles for both farms and wild salmon incubation. Specific to wild salmon restoration, the most current scientific understandings of salmonid embryonic development's need for using water from their indigenous watershed for imprinting to their natal stream, requires new incubation standards/requirements for water use that conventional incubators are challenged to accomplish. Therefore, a need exists for advanced incubation for egg and alevin (larval) stages of development, that is more efficient, portable (when necessary), prohibits fungal/bacterial growth, operates on less water, while providing precise control over water and atmospheric conditions.

Incubators relevant to this disclosure are discussed in the following U.S. Patents, which are hereby incorporated by reference: U.S. Pat. Nos. 4,159,009; 4,742,798; 4,998,505; and 5,156,111; U.S. Pat. No. 8,899,183-B1

### BRIEF SUMMARY OF THE INVENTION

The invention provides a modular aquaculture fluid incubator having at least one housing containing both submerged and unsubmerged incubation spaces and/or an incubation space integrating both unsubmerged and submerged incubation into one space. The system includes integrated fluid management via mechanical pumps, chambers, tubing, filtration, and nozzles that deliver controlled sprays, jets, or streams of liquid to the incubation spaces. Features include gas/chemical/temperature regulation, filtration, environmental monitoring, energy management and construction flexibility through diverse materials and fabrication techniques. The system enhances incubation efficiency, stability, reliability and adaptability across a variety of aquaculture applications.

It is self-evident that the blending of both types of incubation, with associated support systems, is not a simple or predictable improvement over existing technology (obvious) as submerged incubation designs have existed for over 100 years and a unsubmerged incubation design has existed for over 25 years, yet no one has pursued the means to integrate the two types.

### BRIEF DESCRIPTION OF THE SEVERAL VIEWS OF THE DRAWING

Components to drawings are not to scale, emphasis instead being place upon illustrating the principles of the invention. Moreover, in the drawings, like reference numerals designate corresponding parts throughout the several views.

FIG. 1 is a perspective view of existing unsubmerged and submerged incubators.

FIG. 2 is a front plan view of one the aquaculture incubator showing the housing with submerged and unsubmerged incubation spaces and liquid chamber. FIG. 2 does not show detail of the unsubmerged and submerged incubators as the drawing represents a non-limiting embodiment of the present invention due to the exact design of the unsubmerged and submerged incubators will be adjusted for the specific requirements of specimens incubated.

FIG. 3 is a front plan view non-limiting embodiment diagram of the fluid circulation system, unsubmerged and submerged incubation, liquid chamber, mechanical pumps, tubing, filtration, temperature control systems and power back-up system. Use and size of components is dependent upon specimens incubated. Housing and Valves, for controlling fluid circulation, vary in design, are obvious and therefore not shown for simplifying the view.

FIG. 4 is a side plan view non-limiting embodiment diagram of submerged and unsubmerged incubation spaces integrated into one incubation space. This Figure is illustrating the integrated incubation space in the unsubmerged phase of incubation.

FIG. 5 is a side plan view non-limiting embodiment diagram of submerged and unsubmerged incubation spaces integrated into one incubation space. This Figure is illustrating the integrated incubation space in the submerged phase of incubation.

### DETAILED DESCRIPTION OF THE INVENTION

Non-limiting embodiments of the present invention integrate unsubmerged and submerged incubator spaces to maintain metabolite transfer for the salmonid eggs and alevin (larvae).

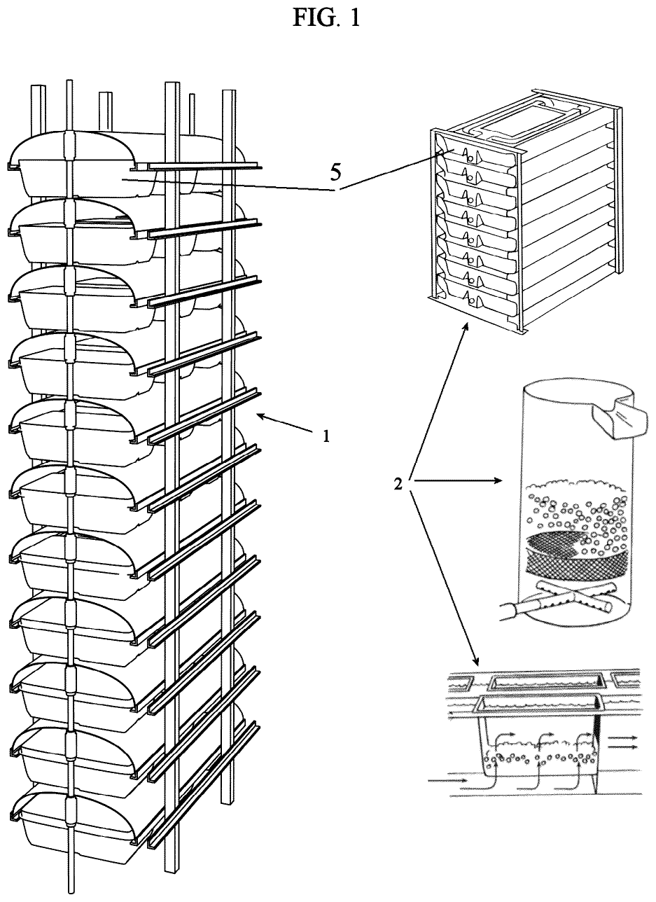

Referring to FIG. 1, the aquaculture incubator comprises unsubmerged 1 and submerged 2 incubation spaces. To better understand this invention and claims, this drawing illustrates one type of unsubmerged incubator and three types of submerged incubator and modular substrate platforms and containers 5. Unsubmerged incubation spaces incubate with delivery of water particles to the specimens while submerged incubation fully submerges specimens.

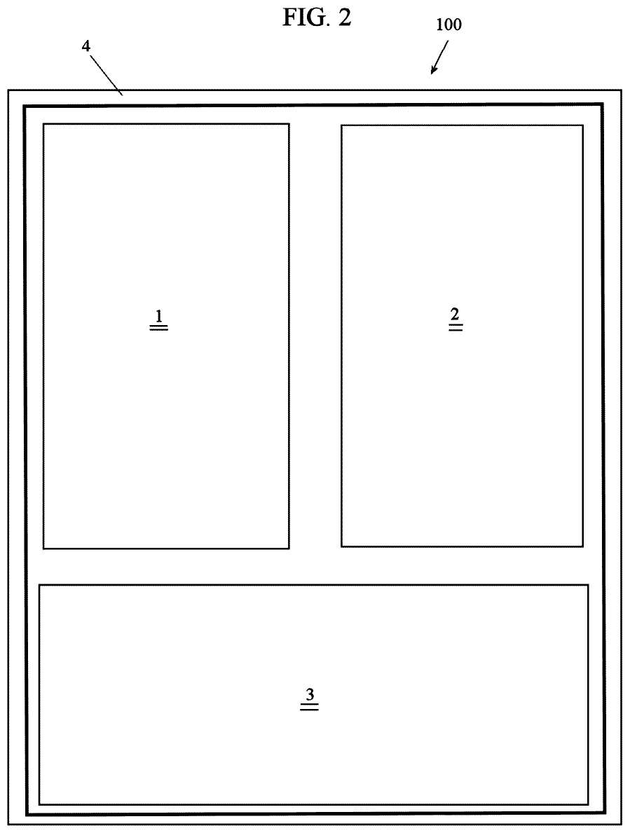

Referring to FIG. 2, the aquaculture incubator comprises at least one insulated 4 housing 100 which encloses at least one unsubmerged incubation space 1, at least one submerged incubation space 2 and a liquid chamber 3. These unsubmerged and submerged incubation spaces may be integrated within the same housing or divided across multiple housings depending on species and/or application requirements.

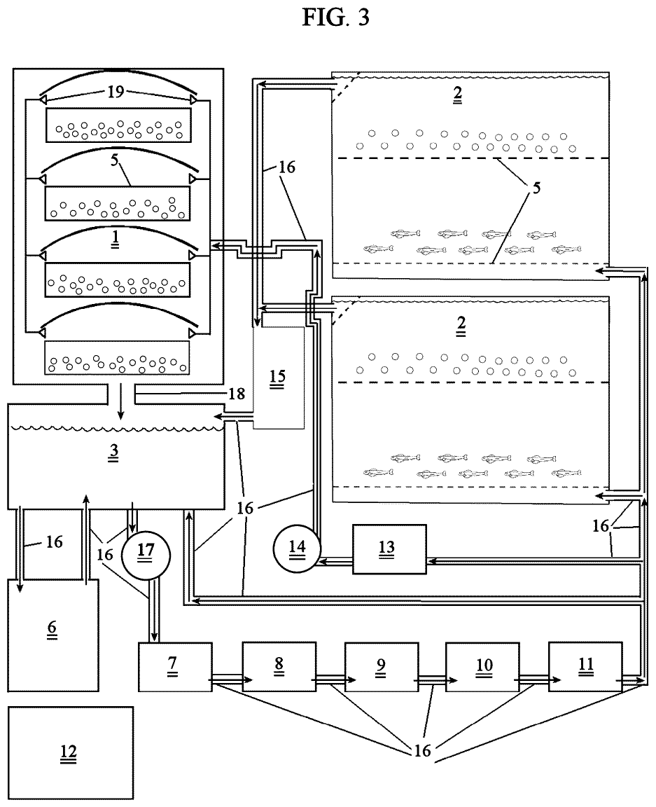

Referring to FIG. 3, A plurality of specimen substrate platforms or containers 5 are disposed within both the unsubmerged 1 and submerged 2 incubation spaces. These may be fixed or removable, and are designed to support a range of specimen types including aquatic eggs, larvae, or other developing organisms.

The incubator includes a liquid chamber 3 containing a liquid medium, typically water. The chamber is fluidly connected to one or more mechanical fluid pump units of low pressure 17 for circulating the liquid through filtration and delivery to submerged incubator space and high pressure 14 for delivery of water to unsubmerged incubator space. This illustration depicts pump units externally mounted; the pumps may be submersible or externally mounted.

Tubing 16 is routed within and/or outside of the housing and chambers to facilitate fluid movement. Tubing networks are configured to transport liquid to and from the liquid chamber 3, high 14 and low 17 pressure pumps, unsubmerged incubation space 1, submerged incubation space 2, Ultraviolet Filtration 7, Ozone Filtration 8, Bio Filtration 9, Packed Column filtration 10, Carbon Filtration 11, Particulate Filtration 13, Protein Skimmer Filtration 15 located inside or outside the housing, and liquid mechanical temperature control system 6. Other forms of filtration may be incorporated, as required and/or become available.

Gravity-fed channels 18 are also utilized to return water from incubator spaces to the liquid chamber 3.

Spray nozzles 19 are positioned within the incubation spaces and are coupled to the tubing to deliver mists, jets, or streams with configurable spray patterns, droplet sizes, and velocities.

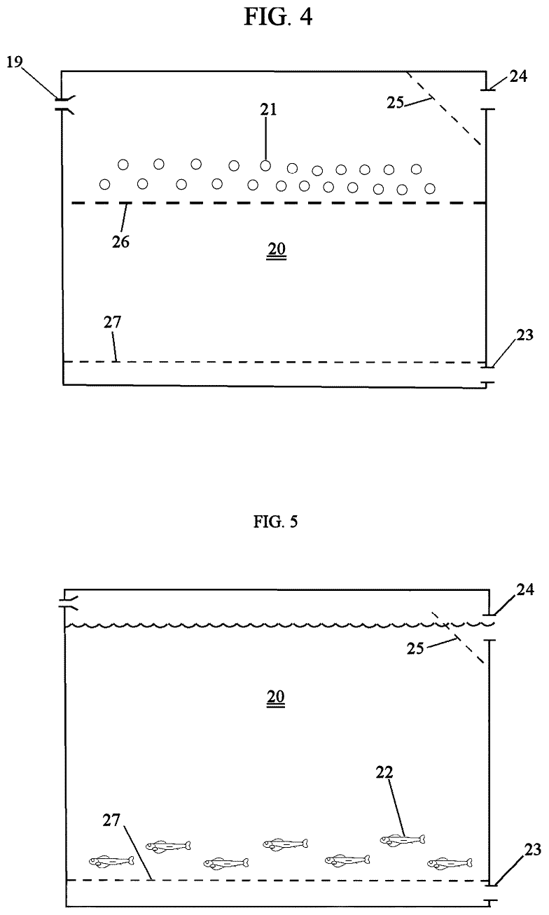

Referring to FIG. 4, the incubator space integrates unsubmerged and submerged incubation functionality in one space. This illustration of the unsubmerged incubation phase has liquid droplets sprayed from the nozzle 19 into the upper incubator space, where the liquid droplets settle on the eggs 21, situated on the upper modular substrate platform 26 (which, in this illustration, is a perforated plate with elongated holes that allow liquid and Alevin (Larvae) to pass through but not eggs). The liquid droplets drain through the eggs where the liquid droplets then fall through both the modular substrate platforms 26, 27. The liquid then discharges out the lower incubator port 23. As the eggs approach the time to hatch, the incubator is flooded with liquid, via the lower port 23, circulating up and around the eggs, flowing past the discharge screen 25 and out the upper port 24. As eggs hatch, the Alevin (larvae) swim down through the upper modular substrate platform 25 and settle upon the lower substrate platform 27. When the eggs all hatch, the upper modular substrate platform 26 is removed. Size of components is dependent upon specimens incubated.

Referring to FIG. 5, the incubator space integrates unsubmerged and submerge incubation functionality in one space. This illustration of the submerged incubation phase has water flowing into the incubation space through the water inlet 23, upwelling through the lower modular substrate platform 27, which, in this illustration, is a perforated plate that allow liquid to pass but not alevin (larvae), circulating around the Alevin (larvae) 22, to fill the incubation space, flowing past the discharge screen 25 and out the discharge port 24.

Nozzles 19 may continue to operate after hatch, to stabilize 02 and CO2 gasses, during incubation of alevin (larvae).

Other features may include:
Modular substrate platforms 5, 26, 27, designed for each aquatic application, to cover eggs and/or partition eggs and alevin (larvae) when appropriate,
Modular substrate platforms 5, 27, designed for each aquatic application, to create artificial habitat for alevin (larvae), when appropriate (not shown),
Thermal insulation 4 applied to housing 100, chambers 3, tubing 16, and incubator spaces 1, 2, 20, promotes spaces that may be temperature-controlled and hermetically/semi-hermetically sealed,
Environmental sensors for monitoring temperature, humidity, and gas composition (not shown),
Gas exchange systems to introduce or remove oxygen, CO₂, or other gases in liquid and atmosphere within incubator (not shown),
Power back-up system 12, and
Electronic control systems and remote monitoring (not shown).

The incubator may be fabricated using various manufacturing techniques including, but not limited to: 3D printing, injection molding, hand fabrication, forming, and vacuum bag molding. Materials may include, but not limited to: polymers, resins, composites, carbon fiber, Kevlar, fiberglass, wood, and metal.

Access doors are appropriately insulated, hinged and sealed as needed and located appropriately where needed, based upon each incubator design variation.

Pre-existing components such as, but not limited to, refrigerators, heaters, pumps, and control electronics may be incorporated into the incubator system.

1. An incubator used in aquaculture, comprising:
(a) at least one housing including:
(i) at least one unsubmerged incubation space disposed within the housing; and
(ii) at least one submerged incubation space disposed within the housing;
(b) a plurality of specimen substrate platforms and/or containers, fixed or removable, situated within the unsubmerged and submerged incubation spaces;
(c) at least one chamber disposed within the housing and may be within or outside of the incubation spaces, the chamber comprising:
(i) a liquid capable of being circulated and/or sprayed as a fine mist by a mechanical pump; and
(ii) at least one mechanical fluid pump unit, wherein the fluid pump unit is submerged within the liquid and/or fluidly connected to the chamber;
(d) tubing for fluid movement, disposed within and/or outside the housing and chamber, fluidly connecting the mechanical fluid pump unit to the unsubmerged and submerged incubation spaces;
(e) tubing for fluid transport, disposed within and/or outside the housing, fluidly connecting the mechanical fluid pump unit to filtration units located within and/or outside of the unsubmerged and submerged incubation spaces, chamber, and housing;
(f) tubing for fluid return, disposed within and/or outside the housing, fluidly connecting the unsubmerged incubation space, submerged incubation space, and/or filtration units for returning liquid to the chamber;
(g) a gravity return system for fluid from the unsubmerged and submerged incubation spaces and/or filtration units to the chamber; and
(h) at least one liquid nozzle disposed within the unsubmerged and submerged incubation spaces, the nozzle being connected to the tubing and adapted to deliver fluid in the form of sprays, jets, or streams having various properties, including droplet size, spray pattern, flow rate, pressure, and velocity.

2. The incubator of claim 1, wherein the unsubmerged and submerged incubation spaces are contained in one or more housings.

3. The incubator of any of claims 1 to 2, wherein the incubation spaces are partitioned into smaller sections to facilitate specimen isolation.

4. The incubator of any of claims 1 to 3, further comprising thermal insulation.

5. The incubator of any of claims 1 to 3, further comprising chemical, biological, and particulate filtration for fluids and atmosphere within the incubation spaces, chamber, and housing.

6. The incubator of any of claims 1 to 3, further comprising mechanical temperature control systems.

7. The incubator of any of claims 1 to 3, further comprising environmental sensors for monitoring liquid and atmospheric conditions.

8. The incubator of any of claims 1 to 3, further comprising mechanical units configured to deliver and remove gases to and from the liquid and atmosphere within the incubation spaces, chamber, and housing.

9. The incubator of any of claims 1 to 3, wherein the liquid comprises water.

10. The incubator of any of claims 1 to 3, wherein the mechanical systems for the unsubmerged and submerged incubation spaces, housing, and chamber are integrated.

11. The incubator of any of claims 1 to 10, wherein the electrical systems may have an electrical monitoring system with battery back-up.

12. The incubator of any of claims 1 to 11, wherein the assemblies and sub-assemblies are manufactured using diverse fabrication techniques including, but not limited to, 3D printing, injection molding, vacuum bag molding, hand layup, welding, fusing and forming.

13. The incubator of any of claims 1 to 12, wherein the assemblies and sub-assemblies are manufactured using various materials including, but not limited to, 3D filaments, plastics, resins, foams, carbon fiber, Kevlar, fiberglass, wood, and metal.

14. The incubator of any of claims 1 to 13, wherein the assemblies and sub-assemblies may integrate pre-existing devices including, but not limited to, freezers, refrigerators, coolers, refrigeration units, heaters, pumps, filters, sensors, and electronic control systems.

15. An incubator wherein unsubmerged and submerged incubation spaces may be integrated into one incubation space.
